(19) United States
(12) Patent Application Publication
(10) Pub. No.: US 2010/0250591 A1
(43) Pub. Date: Sep. 30, 2010

(54) Methods, Systems, And Computer Program Products For Providing Access To Metadata For An Identified Resource

(76) Inventor: Robert P. Morris, Raleigh, NC (US)

Correspondence Address: SCENERA RESEARCH, LLC, 111 CORNING RD., SUITE 220, CARY, NC, 27518, US

(21) Appl. No.: 12/413,850

(22) Filed: Mar. 30, 2009

(51) Int. Cl. G06F 17/30

(52) U.S. Cl. 707/770; 707/E17.032; 707/E17.002; 707/E17.008; 707/E17.044

(57) ABSTRACT

Methods and systems are described for providing access to metadata for an identified resource. Information identifying a resource and a resource domain of a resource provider of the resource is received. A metadata access request (MAR) having the information is generated and transmitted for routing based on the resource domain to a resource directory node for accessing a record associating the resource with metadata for the resource where the metadata is in a domain represented by a metadata repository node. An accessor for accessing the metadata is received in response to the MAR.

In another aspect, an update message identifying a resource and a metadata-schema domain is received. A record associating the resource and domain is updated. A response including an accessor based on the domain for accessing the metadata for the resource identified by the metadata access request is generated and transmitted as a response to the MAR.

### RELATED APPLICATIONS

This application is related to commonly owned U.S. patent application Ser. No. ______, titled “Method and System for Providing Access to Metadata of a Network Accessible Resource”, filed on Mar. 30, 2009, the entire disclosure of which is hereby incorporated by reference herein.

### BACKGROUND

Uniform resource locators (URLs) are used to locate specific resources. The discovery of information resources and/or other related resources for a URL identified resource is typically performed via a web search engine. Search results from the web search engine typically yield incomplete results that include a vast amount of irrelevant information that greatly increase the effort required finding the information resources and/or other related resources.

Most web accessible resources are associated with a schema defining one or more of a resource's format, structure, vocabulary, and/or semantics. HTML, for example, has a schema defined by the World Wide Web Consortium (W3C) specifying, among other things, valid tags, the structure of valid HTML documents, and attributes associated with tags. In fact, HTML documents and most other markup based resources, e.g., XML based resources, can include the schema for the resource and/or a reference to the schema in the resource. Alternatively, the schema and/or the reference to the schema can be provided with the resource. Non-text resources, such as images, can also have schemas, such as EXIF and TIFF, defining their format, sematincs, and/or content. Similarly, other media types including executable media types, such as Javascript resources and/or Java resources, can have schemas defining their format, semantics, and/or content.

Identifying a schema for validating a data object such as a specific resource is currently performed by including a URL for the schema in the data object. Given a schema URL, locating information conforming to the schema is very difficult, but possible using ad hoc methods designed for individual schemas, by discovering the data, for example, by a “bot”.

### SUMMARY

Accordingly, there exists a need for methods, systems, and computer program products for locating metadata for an identified resource.

Methods and systems are described for providing access to metadata for an identified resource. In one aspect of the subject matter disclosed herein, resource information identifying a resource and identifying a resource domain is received. The resource domain includes a resource provider configured to provide access to the resource. A metadata access request identifying the resource and identifying the resource domain based on the resource information is generated and transmitted for routing based on the resource domain to a resource directory node representing the resource domain for accessing a record associating the resource with metadata for the resource where the metadata is in a metadata-schema domain represented by a metadata repository node. An accessor for accessing the metadata is received in response to the metadata access request.

In another aspect of the subject matter disclosed herein, a system for providing access to metadata for an identified resource includes system components including a resolver interface component, a messaging agent component, and a resource directory client component. The resource interface component is configured to receive resource information identifying a resource and identifying a resource domain of a resource provider of the resource. The messaging agent component is configured to generate a metadata access request identifying the resource and identifying the resource domain based on the resource information. The resource directory client component is configured to transmit the metadata access request for routing based on the resource domain to a resource directory node representing the resource domain for accessing a record associating the resource with metadata for the resource. The metadata is in a metadata-schema domain represented by a metadata repository node. The resource directory client component is further configured to receive an accessor for accessing the metadata in response to the metadata access request.

In another aspect of the subject matter disclosed herein, a computer readable medium stores a computer program, executable by a machine, for providing access to metadata for an identified resource. The computer program comprises executable instructions for receiving resource information identifying a resource and identifying a resource domain of a resource provider of the resource. The computer program includes further executable instructions for generating a metadata access request identifying the resource and identifying the resource domain based on the resource information. The computer program includes further executable instructions for transmitting the metadata access request for routing based on the resource domain to a resource directory node for accessing a record associating the resource with metadata for the resource. The metadata is in a metadata-schema domain represented by a metadata repository node. The computer program includes further executable instructions for receiving an accessor for accessing the metadata in response to the metadata access request.

In another aspect of the subject matter disclosed herein, an update message identifying a resource and a metadata-schema domain is received. A record associating the resource and the metadata-schema domain is updated. A metadata access response identifying an accessor based on the metadata-schema domain for accessing metadata, in the metadata-schema domain, for a resource identified by a metadata access request that is received is generated and transmitted as a response to the metadata access request.

In another aspect of the subject matter disclosed herein, a system for providing access to metadata for an identified resource has system components including a domain manager component, a resource association agent, and a client message handler component. The domain manager component is configured to receive an update message identifying a resource and a metadata-schema domain. The resource association agent component is configured to update a record associating the resource and the metadata-schema domain. The client message handler component is configured to receive a metadata access request identifying the resource and generate a metadata access response including an accessor based on the metadata-schema domain for accessing metadata, in the metadata-schema domain, for the resource identified by the metadata access request. The client message handler component is further configured to transmit the metadata access response as a response to the metadata access request.

In another aspect of the subject matter disclosed herein, a computer readable medium stores a computer program, executable by a machine, for providing access to metadata for an identified resource. The computer program comprises executable instructions for receiving an update message identifying a resource and a metadata-schema domain. The computer program comprises further executable instructions for updating a record associating the resource and the metadata-schema domain. The computer program comprises further executable instructions for receiving a metadata access request identifying the resource. The computer program comprises further executable instructions for generating a metadata access response including an accessor based on the identified metadata-schema domain. The accessor is for accessing metadata in the metadata-schema domain. The metadata is metadata for the resource identified by the metadata access request. The computer program comprises further executable instructions for transmitting the metadata access response as a response to the metadata access request

### BRIEF DESCRIPTION OF THE DRAWINGS

Advantages of the claimed subject matter will become apparent to those skilled in the art upon reading this description in conjunction with the accompanying drawings, in which like reference numerals have been used to designate like or analogous elements, and in which:

FIG. 1 is a block diagram illustrating an exemplary hardware device in which the subject matter may be implemented;

FIG. 2 is a flow diagram illustrating a method for providing access to metadata for an identified resource according to an aspect of the subject matter described herein;

FIG. 3 is a block diagram illustrating an arrangement of components for providing access to metadata for an identified resource according to another aspect of the subject matter described herein;

FIG. 4 is a block diagram illustrating an arrangement of components providing an execution environment configured to host the arrangement of components of FIG. 3;

FIG. 5a is a block diagram illustrating a network having a node hosting an execution environment corresponding to the environment of FIG. 4 for hosting the components of FIG. 3 communicating with a resource directory node according to an aspect of the subject matter described herein;

FIG. 5b is a block diagram illustrating a network having a node hosting an execution environment corresponding to the environment of FIG. 4 for hosting the components of FIG. 3 communicating with a resource directory node according to another aspect of the subject matter described herein;

FIG. 6 is a flow diagram illustrating a method for providing access to metadata for an identified resource according to another aspect of the subject matter described herein;

FIG. 7 is a block diagram illustrating an arrangement of components for providing access to metadata for an identified resource according to another aspect of the subject matter described herein;

FIG. 8 is a block diagram illustrating an arrangement of components providing an execution environment configured to host the arrangement of components of FIG. 7;

FIG. 9 is a flow diagram illustrating a method for providing access to metadata for an identified resource according to another aspect of the subject matter described herein;

FIG. 10 is a block diagram illustrating an arrangement of components for providing access to metadata for an identified resource according to another aspect of the subject matter described herein;

FIG. 11 is a block diagram illustrating an arrangement of components providing an execution environment configured to host the arrangement of components of FIG. 10; and

FIG. 12 is a flow diagram illustrating a method for providing access to metadata for an identified resource according to another aspect of the subject matter described herein.

### DETAILED DESCRIPTION

The subject matter presented herein provides for identifying a metadata-schema domain including metadata for an identified resource. A metadata repository node representing the metadata-schema domain can have a record referencing an identified resource. Each resource is in a resource domain based on a domain, referred to as a resource domain, of a provider, referred to as a resource provider, of the resource. A resource directory service can represent a domain and maintain associations (e.g., records) between a resource in the resource domain and one or more metadata-schema domains. Each metadata-schema domain includes one or more schemas having identifiers based on an identifier of the metadata-schema domain. Metadata can be valid according to a schema and thus be included in the metadata domain of the schema. The association allows a resource directory service to identify metadata associated with an identified resource by a metadata repository node representing a metadata-schema domain based on a metadata-schema domain associated with the resource. A metadata repository node can maintain an association between a resource and metadata where the metadata is valid according to a schema in a metadata-schema domain represented by the metadata repository node. A metadata domain can be associated with a resource via an identifier of a metadata-schema domain. A schema identifier and/or an identifier of particular metadata can include or otherwise identify a metadata-schema domain that includes the schema and or metadata.

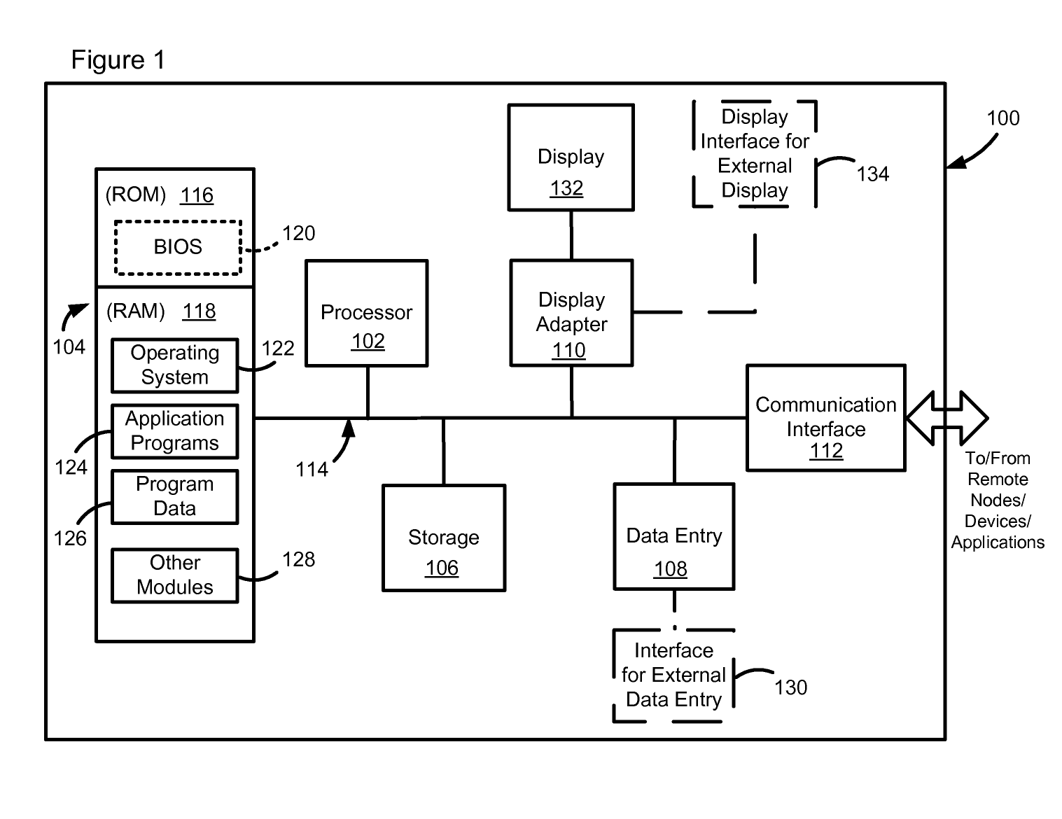

Prior to describing the subject matter in detail, an exemplary hardware device in which the subject matter may be implemented shall first be described. Those of ordinary skill in the art will appreciate that the elements illustrated in FIG. 1 may vary depending on the system implementation. With reference to FIG. 1, an exemplary system for implementing the subject matter disclosed herein includes a hardware device 100, including a processing unit 102, memory 104, storage 106, data entry module 108, display adapter 110, communication interface 112, and a bus 114 that couples elements 104-112 to the processing unit 102.

The bus 114 may comprise any type of bus architecture. Examples include a memory bus, a peripheral bus, a local bus, etc. The processing unit 102 is an instruction execution machine, apparatus, or device and may comprise a microprocessor, a digital signal processor, a graphics processing unit, an application specific integrated circuit (ASIC), a field programmable gate array (FPGA), etc. The processing unit 102 may be configured to execute program instructions stored in memory 104 and/or storage 106 and/or received via data entry module 108.

The memory 104 may include read only memory (ROM) 116 and random access memory (RAM) 118. Memory 104 may be configured to store program instructions and data during operation of device 100. In various embodiments, memory 104 may include any of a variety of memory technologies such as static random access memory (SRAM) or dynamic RAM (DRAM), including variants such as dual data rate synchronous DRAM (DDR SDRAM), error correcting code synchronous DRAM (ECC SDRAM), or RAMBUS DRAM (RDRAM), for example. Memory 104 may also include nonvolatile memory technologies such as nonvolatile flash RAM (NVRAM) or ROM. In some embodiments, it is contemplated that memory 104 may include a combination of technologies such as the foregoing, as well as other technologies not specifically mentioned. When the subject matter is implemented in a computer system, a basic input/output system (BIOS) 120, containing the basic routines that help to transfer information between elements within the computer system, such as during start-up, is stored in ROM 116.

The storage 106 may include a flash memory data storage device for reading from and writing to flash memory, a hard disk drive for reading from and writing to a hard disk, a magnetic disk drive for reading from or writing to a removable magnetic disk, and/or an optical disk drive for reading from or writing to a removable optical disk such as a CD ROM, DVD or other optical media. The drives and their associated computer-readable media provide nonvolatile storage of computer readable instructions, data structures, program modules and other data for the hardware device 100. It is noted that the methods described herein can be embodied in executable instructions stored in a computer readable medium for use by or in connection with an instruction execution machine, apparatus, or device, such as a computer-based or processor-containing machine, apparatus, or device. It will be appreciated by those skilled in the art that for some embodiments, other types of computer readable media may be used which can store data that is accessible by a computer, such as magnetic cassettes, flash memory cards, digital video disks, Bernoulli cartridges, RAM, ROM, and the like may also be used in the exemplary operating environment. As used here, a “computer-readable medium” can include one or more of any suitable media for storing the executable instructions of a computer program in one or more of an electronic, magnetic, optical, and electromagnetic format, such that the instruction execution machine, system, apparatus, or device can read (or fetch) the instructions from the computer readable medium and execute the instructions for carrying out the described methods. A non-exhaustive list of conventional exemplary computer readable medium includes: a portable computer diskette; a RAM; a ROM; an erasable programmable read only memory (EPROM or flash memory); optical storage devices, including a portable compact disc (CD), a portable digital video disc (DVD), a high definition DVD (HD-DVD™), a BLU-RAY disc; and the like.

A number of program modules may be stored on the storage 106, ROM 116 or RAM 118, including an operating system 122, one or more applications programs 124, program data 126, and other program modules 128. A user may enter commands and information into the hardware device 100 through data entry module 108. Data entry module 108 may include mechanisms such as a keyboard, a touch screen, a pointing device, etc. Other external input devices (not shown) are connected to the hardware device 100 via external data entry interface 130. By way of example and not limitation, external input devices may include a microphone, joystick, game pad, satellite dish, scanner, or the like. In some embodiments, external input devices may include video or audio input devices such as a video camera, a still camera, etc. Data entry module 108 may be configured to receive input from one or more users of device 100 and to deliver such input to processing unit 102 and/or memory 104 via bus 114.

A display 132 is also connected to the bus 114 via display adapter 110. Display 132 may be configured to display output of device 100 to one or more users. In some embodiments, a given device such as a touch screen, for example, may function as both data entry module 108 and display 132. External display devices may also be connected to the bus 114 via external display interface 134. Other peripheral output devices, not shown, such as speakers and printers, may be connected to the hardware device 100.

The hardware device 100 may operate in a networked environment using logical connections to one or more remote nodes (not shown) via communication interface 112. The remote node may be another computer, a server, a router, a peer device or other common network node, and typically includes many or all of the elements described above relative to the hardware device 100. The communication interface 112 may interface with a wireless network and/or a wired network. Examples of wireless networks include, for example, a BLUETOOTH network, a wireless personal area network, a wireless 802.11 local area network (LAN), and/or wireless telephony network (e.g., a cellular, PCS, or GSM network). Examples of wired networks include, for example, a LAN, a fiber optic network, a wired personal area network, a telephony network, and/or a wide area network (WAN). Such networking environments are commonplace in intranets, the Internet, offices, enterprise-wide computer networks and the like. In some embodiments, communication interface 112 may include logic configured to support direct memory access (DMA) transfers between memory 104 and other devices.

In a networked environment, program modules depicted relative to the hardware device 100, or portions thereof, may be stored in a remote storage device, such as, for example, on a server. It will be appreciated that other hardware and/or software to establish a communications link between the hardware device 100 and other devices may be used.

It should be understood that the arrangement of hardware device 100 illustrated in FIG. 1 is but one possible implementation and that other arrangements are possible. It should also be understood that the various system components (and means) defined by the claims, described below, and illustrated in the various block diagrams represent logical components that are configured to perform the functionality described herein. For example, one or more of these system components (and means) can be realized, in whole or in part, by at least some of the components illustrated in the arrangement of hardware device 100. In addition, while at least one of these components are implemented at least partially as an electronic hardware component, and therefore constitutes a machine, the other components may be implemented in software, hardware, or a combination of software and hardware. More particularly, at least one component defined by the claims is implemented at least partially as an electronic hardware component, such as an instruction execution machine (e.g., a processor-based or processor-containing machine) and/or as specialized circuits or circuitry (e.g., discrete logic gates interconnected to perform a specialized function), such as those illustrated in FIG. 1. Other components may be implemented in software, hardware, or a combination of software and hardware. Moreover, some or all of these other components may be combined, some may be omitted altogether, and additional components can be added while still achieving the functionality described herein. Thus, the subject matter described herein can be embodied in many different variations, and all such variations are contemplated to be within the scope of what is claimed.

In the description that follows, the subject matter will be described with reference to acts and symbolic representations of operations that are performed by one or more devices, unless indicated otherwise. As such, it will be understood that such acts and operations, which are at times referred to as being computer-executed, include the manipulation by the processing unit of data in a structured form. This manipulation transforms the data or maintains it at locations in the memory system of the computer, which reconfigures or otherwise alters the operation of the device in a manner well understood by those skilled in the art. The data structures where data is maintained are physical locations of the memory that have particular properties defined by the format of the data. However, while the subject matter is being described in the foregoing context, it is not meant to be limiting as those of skill in the art will appreciate that various of the acts and operation described hereinafter may also be implemented in hardware.

To facilitate an understanding of the subject matter described below, many aspects are described in terms of sequences of actions. At least one of these aspects defined by the claims is performed by an electronic hardware component. For example, it will be recognized that the various actions can be performed by specialized circuits or circuitry, by program instructions being executed by one or more processors, or by a combination of both. The description herein of any sequence of actions is not intended to imply that the specific order described for performing that sequence must be followed. All methods described herein can be performed in any suitable order unless otherwise indicated herein or otherwise clearly contradicted by context.

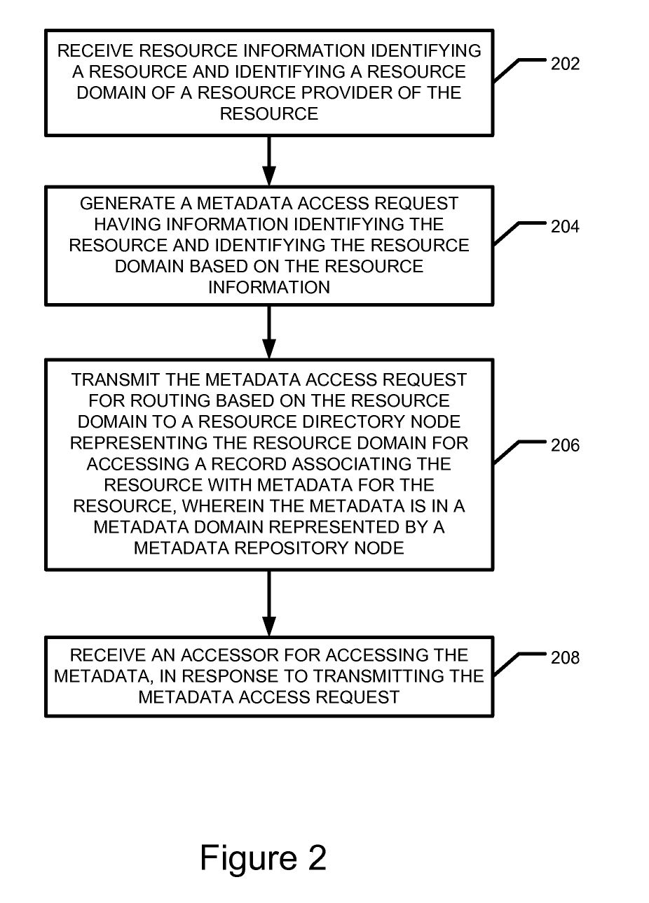

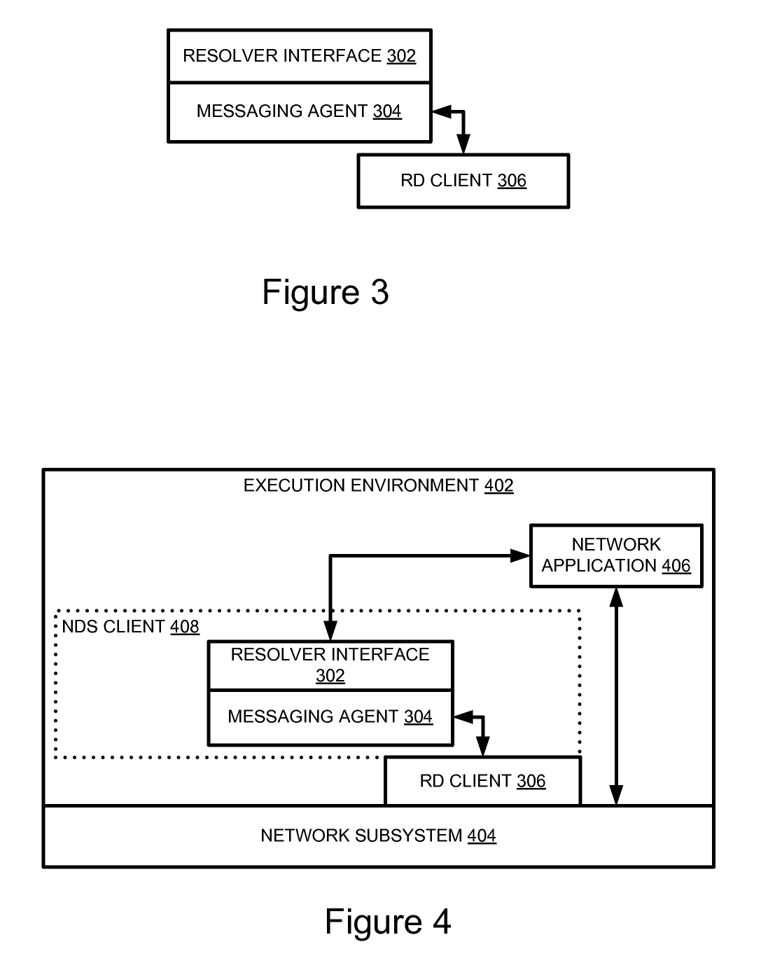

Turning now to FIG. 2, a flow diagram is illustrated illustrating a method for providing access to metadata for an identified resource according to an exemplary aspect of the subject matter described herein. FIG. 3 is a block diagram illustrating an arrangement of components for providing access to metadata for an identified resource according to another exemplary aspect of the subject matter described herein. FIG. 4 is a block diagram illustrating an arrangement of components providing an execution environment configured for hosting the arrangement of components depicted in FIG. 3. The method in FIG. 2 can be carried out by, for example, some or all of the components illustrated in the exemplary arrangement in FIG. 3 operating in an a compatible execution environment, such as the environment provided by some or all of the components of the arrangement in FIG. 4. The arrangement of components in FIG. 4 may be implemented by some or all of the components of the hardware device 100 of FIG. 1.

With reference to FIG. 2, in block 202 resource information identifying a resource and identifying a resource domain of a resource provider of the resource is received. Accordingly, a system for providing access to metadata for an identified resource includes means for receiving resource information identifying a resource and identifying a resource domain of a resource provider of the resource. For example, as illustrated in FIG. 3, a resolver interface component 302 is configured to receive resource information identifying a resource and identifying a resource domain of a resource provider of the resource. The resource is any resource that can be accessed via a network such as, for example, the Internet.

According to an exemplary embodiment, the resource information may be received over a network in a received message and/or from a local source. For example, the received message can be a response to a request, a notification associated with a subscription, and/or an unsolicited asynchronous message. The local source may be the URL of a locally stored resource and/or can be received as input from a user. The resolver interface component 302 can be called by any network application such as a browser or an instant messaging client.

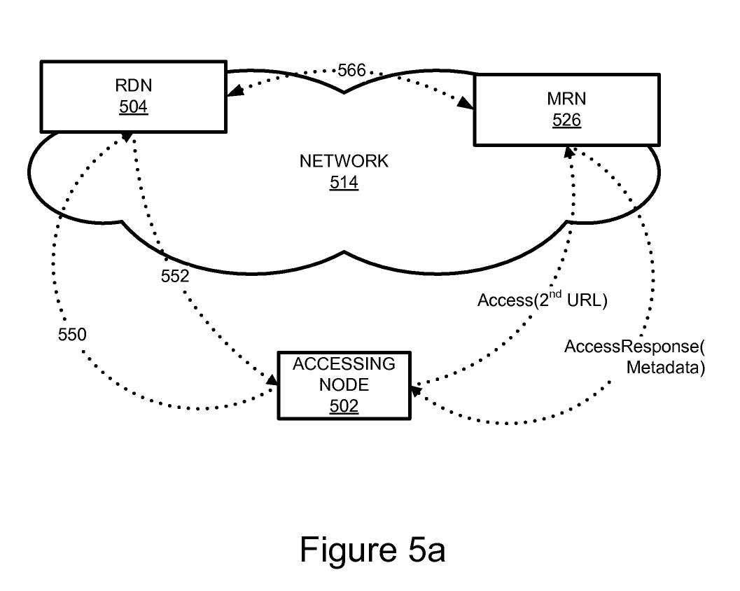

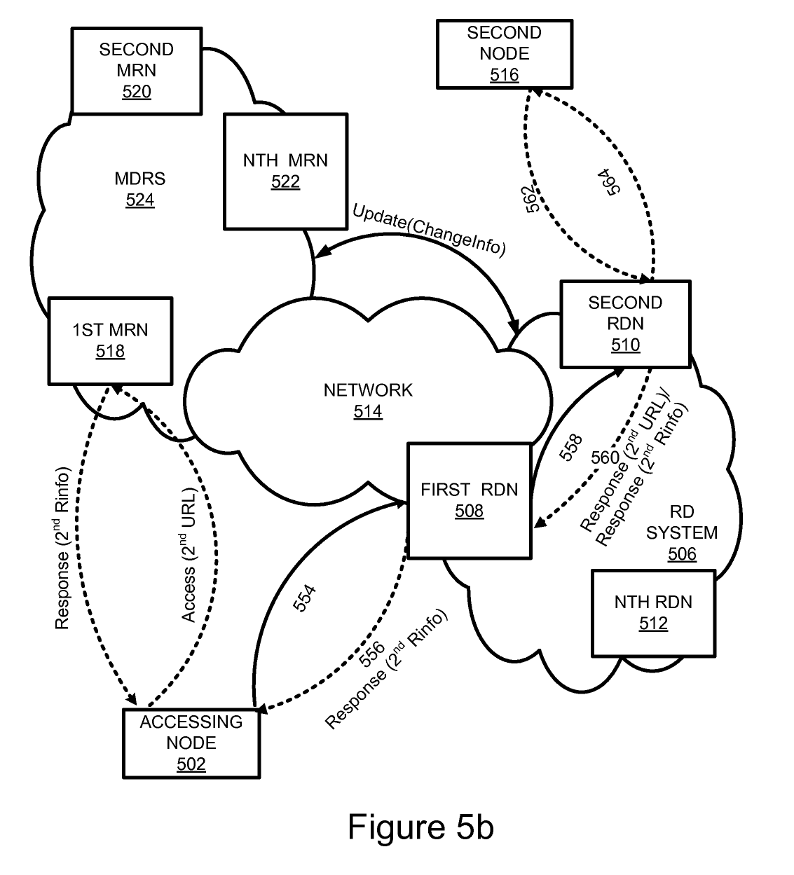

According to one embodiment, the components illustrated in FIG. 3, including the resolver interface component 302, can be adapted to operate in an execution environment 402 illustrated in FIG. 4 provided by a node, such as accessing node 502 illustrated in FIG. 5. For example, the execution environment 402 may host a network application 406, such as a browser, that receives the resource information as a URL or other suitably formatted data identifying the resource and resource domain via the location bar of the browser, a bookmark, in an HTTP response header, or in a web page or other resourced received from a resource provider via network subsystem 404. The resolver interface component 302 can be included in a network directory service (NDS) client 408.

Returning to FIG. 2, in block 204 a metadata access request is generated having information that identifies the resource and that identifies the resource domain. Accordingly, a system for providing access to metadata for an identified resource includes means for generating a metadata access request identifying the resource and identifying the resource domain. For example, as illustrated in FIG. 3, a messaging agent component 304 is configured to generate a metadata access request identifying the resource and identifying the resource domain.

The resolver interface component 302 can support more than one directory service. For example, resolver interface component 302 can determine the directory service to send a message to based on a domain namespace of a domain identifier identified in the received resource information. For example, the resource information identifies a resource domain in a particular resource domain namespace. The resolver interface component 302 can be configured to provide the information identifying the resource and identifying the resource domain to a particular messaging agent based on the identified domain. In FIG. 4, the resolver interface component 302 is configured to interoperate with a messaging agent component 304 for a resource directory service and/or resource directory system supporting one or more domain name spaces.

FIG. 5a illustrates a resource directory node (RDN) 504 configured to host a resource directory (RD) service representing a domain in a domain namespace including the domain identified in the resource information. FIG. 5b illustrates a resource directory (RD) system 506 including a first RDN 508, a second RDN 510, and one or more other RDNs including an Nth RND 512. The RDNs illustrated host one or more RD services each representing a resource domain in a resource domain space represented by the RD system 506. The RDN 504 may represent a domain in a different domain name space than the domain name space represented by the RD system 506 and its RDNs including the first RDN 508, the second RDN 510, the Nth RDN 512, and possible other RDNs in the RD system 506. Based on the domain identifier received in the resource information, the resolver interface component 302 interoperates with a messaging agent component that is compatible with the directory service/system representing the domain namespace including the identified domain to generate a metadata access request.

The messaging agent component 304 receives information identifying the resource and the resource domain based on the received resource information from the resolver interface component 302. The messaging agent component 304 illustrated generates the metadata access request identifying the resource and identifying the resource domain based on resource information received by the resolver interface component 302. The metadata access request can include the resource information, an identifier of the resource and/or an identifier of the resource domain. For example, the metadata access request can include a URL of the resource. The URL can identify the resource and can identify the resource domain of the resource provider of the resource as supported by various URL schemes including HyperTransfer Text Protocol (HTTP), File Transfer Protocol (FTP), MAILTO, Extensible Messaging and Presence Protocol (XMPP),etc.

Returning to FIG. 2, in block 206 the metadata access request is transmitted for routing based on the resource domain to a resource directory node for accessing a record associating the resource with metadata for the resource. The metadata is in a metadata-schema domain represented by a metadata repository node. Accordingly, a system for providing access to metadata for an identified resource includes means for transmitting the metadata access request for routing based on the resource domain to a resource directory node representing the resource domain for accessing a record associating the resource with metadata for the resource, wherein the metadata is in a metadata-schema domain represented by a metadata repository node. For example, as illustrated in FIG. 3, a resource directory (RD) client component 306 is configured to transmit the metadata access request for routing based on the resource domain to a resource directory node representing the resource domain for accessing a record associating the resource with metadata for the resource, wherein the metdata is in a metadata-schema domain represented by a metadata repository node.

In FIG. 4, the RD client component 306 is illustrated as adapted for operation in the execution environment 402. The RD client component 306 can transmit the metadata access request via network subsystem 404. As described above, the accessing node 502 illustrated in FIG. 5a can provide the execution environment 402 hosting the components illustrated in FIG. 4. The network subsystem component 404 can be operatively coupled to the network 514 and can transmit the metadata access request via the network 514 to the RDN 504 representing a resource domain space including the identified resource domain. Alternatively, the identified resource domain can be in a resource domain name space represented by a RD system analogous to the RD system 506 illustrated in FIG. 5b. In this case the RD client component 306 can interoperate with the network subsystem component 404 to transmit the metadata access request to a node in the RD system 406, such as the first RDN 508 for routing within the RD system 506 to an RDN based on the resource domain identified. Each RDN 508, 510, 512 can represent one or more resource domains in the resource domain name space. The metadata access request can be routed to an RDN representing a resource domain that at least partially includes the resource domain identified in the request access message.

Transmitting the metadata access request includes determining a network address of a node configured to route the metadata access request to the resource directory service. The address of the node configured to route the metadata access request can be provided as configuration data to the messaging agent component 304 and/or the RD client component 306. The configuration information can be received from a user, a configuration service such as a Dynamic Host Configuration Protocol (DCHP) service or Lightweight Directory Access Protocol (LDAP) service, and/or can be provided by an application such as the network application 406. The metadata access request is transmitted using a protocol compatible with the resource directory service. Exemplary protocols include HTTP, Simple Object Access Protocol (SOAP), Extensible Messaging and Presence Protocol: Instant Messaging (XMPP-IM), LDAP, Domain Name System (DNS) protocol, and/or a proprietary protocol.

Returning to FIG. 2, in block 208 an accessor for accessing the metadata is received in response to the metadata access request. Accordingly, a system for providing access to metadata for an identified resource includes means for receiving an accessor for accessing the metadata in response to the metadata access request. For example, as illustrated in FIG. 3, the resource directory service component 306 is further configured to receive an accessor for accessing the metadata in response to the metadata access request.

An accessor can include information identifying a metadata-schema domain represented by a metadata repository node (MRN) hosting a metadata repository (MR) service representing a metadata-schema domain including the identified metadata-schema domain. A metadata-schema domain can be identified by an identifier of a schema where the schema identifier identifies a domain in a metadatata domain represented by an MRN. Alternatively or additionally, an accessor can include a URL. The URL can identify and locate particular metadata, and/or identify and locate a particular MRN.

A message flow between an accessing node 502 and a stand-alone RDN 504 is illustrated in FIG. 5a. The accessing node 502 receives resource information as described above. For example, as indicated previously, the accessing node 502 might host a browser (illustrated as network application 406) that receives a URL via the location bar of a browser, a bookmark, in an HTTP response header, or in a web page or other resourced received from a resource provider and sends the URL to the resolver interface component 302. The browser requires one or more accessors (e.g., uniform resource identifiers (URIs)/URLs) in order to access metadata for the identified resource. To obtain the one or more accessors, the messaging agent component 304 generates a metadata access request message based on the resource information. The metadata access request message identifies the resource and the resource domain and is routed by the RDS client component 306 based on the resource domain identified in the metadata access request. The RDN 504 represents a resource domain space including the identified resource domain. The RDN 504 can be the resource provider of the resource. The metadata access request is transmitted by the RD client 306 via the network subsystem 404 and the network 514, to the RDN 504, as illustrated by message 550, based on the resource domain identified in the metadata access request. The message 550 is received by the RDN and processed as described below. The RDN 550 sends a metadata access response 552 as part of the processing of the received metadata access request message 550. The metadata access response includes an accessor such a schema identifier and/or metadata-schema domain identifier that is received by the RD client component 306 operating in the accessing node 502.

FIG. 5b illustrates an alternative message flow between an accessing node 502 and a RD system such as the RD system 506 including a multiple RDNs, such as the first RD 508, the second RDN 510, the Nth RDN 512, and optionally other RDNs. The accessing node 502 receives resource information as described above. As above, to an accessor for metadata for an identified resource the messaging agent component 304 generates a metadata access request based on received resource information. The metadata access request message identifying the resource and identifying the resource domain is routed by the RDS client component 306 based on the resource domain identified in the metadata access request. The RD system 506 represents a resource domain space including the identified resource domain. The metadata access request is transmitted by the RD client component 306 via the network subsystem 404 and the network 514, to node in the RD system 506, such as the RDN 508, as illustrated by message 554, based on the resource domain identified in the metadata access request. The message 550 is received by the RDN and processed as described below. If the RDN 508 represents a metadata-schema domain that at least partially includes the metadata-schema domain identified in the message 554, the RDN 508 sends a metadata access response 556 as part of the processing of the received metadata access request message 554. The metadata access response includes an accessor such a schema identifier and/or metadata-schema domain identifier that is received by the RD client 306 operating in the accessing node 502. If the resource domain is at least not partially included the metadata domain represented by first RDN 508, the first RDN routes a message illustrated as a message 558 via the RD system 506 to an RND, such as the second RND 510 that represents a second metadata-schema domain that at least partially includes the resource domain represents. In response to receiving the message 558 the second RDN 510 can send a message 560 including an accessor for routing the accessor via the RD system 506 and/or network 514 to the accessing node to be received by the RD client component 306 as described above.

The accessor can include metadata for the identified resource. The metadata can be maintained by an RDN. Alternatively or additionally, the metadata can be accessed from a node maintaining the metadata as illustrated by the second node and the request message 562 and response message 564 exchanged by the second RDN 510 and the second node 516. The node maintaining the metadata can be a metadata repository node (MRN) such as a first MRN 518, a second MRN 520, and Nth MRN 522, and/or other MRN included in a metadata repository system (MDRS) 524 as illustrated in FIG. 5b or a stand-alone MRN as illustrated by MRN 526 in FIG. 5a.

Those skilled in the art will understand that other message flows including other nodes can communicate a metadata access request and a metadata access response. In fact, a protocol supporting an asynchronous protocol model including a publish-subscribe protocol model can be used instead or in addition to a protocol supporting a request-response model.

An RDN representing the domain of the resource can maintain associations between the resource and stored metadata. The associations can identify the resource and specific metadata records, schemas with conforming records, a metadata-schema domain, and/or can have an address of the metadata repository node (MRN) that stores the metadata records associated with the resource. Note that a schema is one type of a metadata-schema domain identifier. An identifier of a record in an MRN can include an identifier of or otherwise identify a metadata-schema domain. The metadata can be stored according to one or more schemas included in a metadata-schema domain. An accessor can locate one or more metadata resources conforming to one or more schemas included in one or more metadata-schema domains represented by one or more corresponding MRNs in an MDRS representing a metadata-schema domain name space including the one or more metadata-schema domains identified by the accessor.

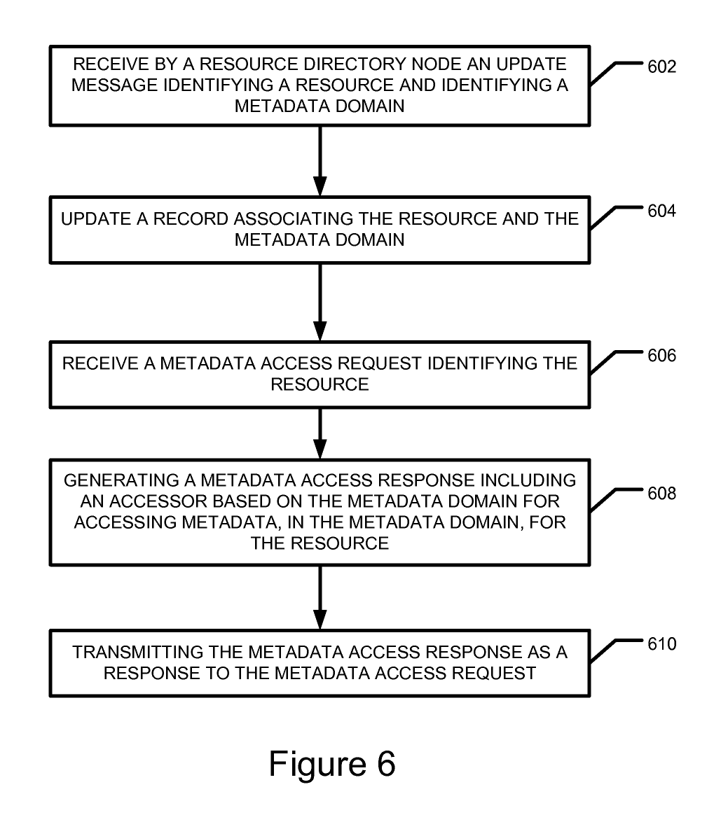

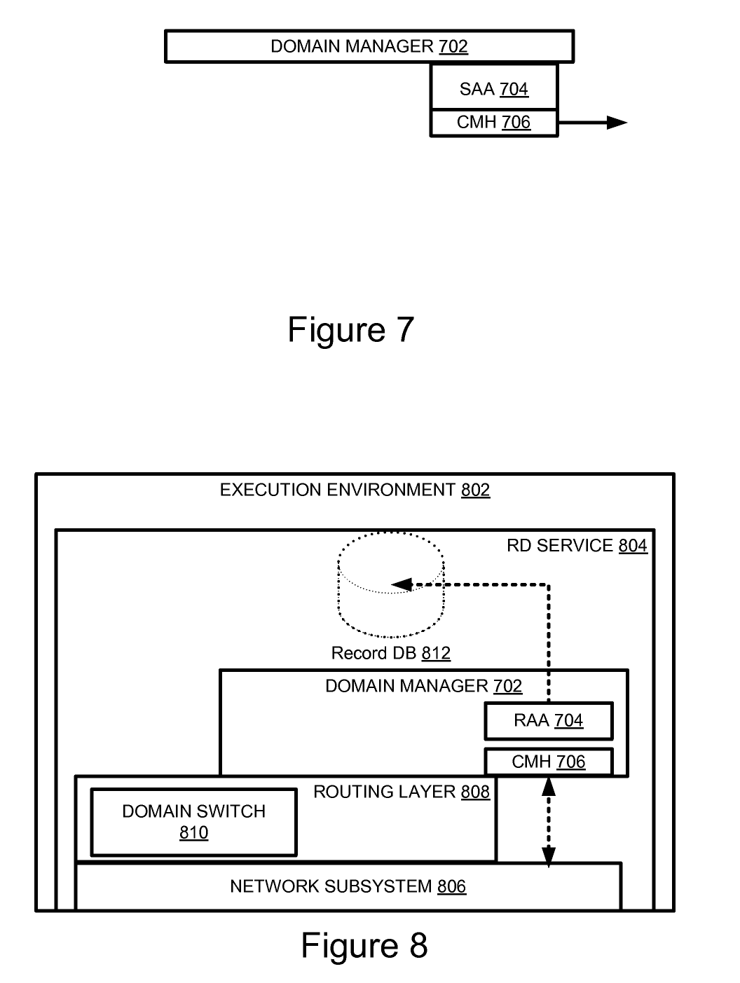

FIG. 6 is a flow diagram illustrating a method for providing access to metadata for an identified resource according to an exemplary aspect of the subject matter described herein. FIG. 7 is a block diagram illustrating a system for providing access to metadata for an identified resource according to another exemplary aspect of the subject matter described herein. FIG. 8 is a block diagram illustrating an arrangement of components providing an execution environment configured for hosting the arrangement of components depicted in FIG. 7. The method in FIG. 6 can be carried out by, for example, some or all of the components illustrated in the exemplary arrangement in FIG. 7 operating in an a compatible execution environment, such as the environment provided by some or all of the components of the arrangement in FIG. 8. The arrangement of components in FIG. 8 may be implemented by some or all of the components of the hardware device 100 of FIG. 1.

With reference to FIG. 6, in block 602 an update message identifying a resource and identifying a metadata-schema domain is received. Accordingly, a system for providing access to metadata for an identified resource includes means for receiving an update message identifying a resource and identifying a metadata-schema domain For example, as illustrated in FIG. 7, a domain manager component 702 is configured to receive an update message identifying a resource and identifying a metadata-schema domain

According to an exemplary embodiment, the update message may be received over a network in a received message and/or from a local source. For example, the received update message can be a response to a request, a notification associated with a subscription, and/or an unsolicited asynchronous message. The local source may be input received from a user.

As described above a metadata-schema domain can be identified by a name or other identifier type, such as at least a portion of a network address, in a metadata-schema domain name space. Alternatively or additionally, a metadata-schema domain can be identified by a schema identifier and/or by an identifier or a particular metadata resource which can include other metadata resources. If no metadata-schema domain is specified in the update message, a default metadata-schema domain can be identified based on a configured default. For example, if the RDN receiving the update message hosts or is otherwise associated with a particular resource provider, the resource provider can identify one or more metadata-schema domains including schemas defining valid metadata for one or more resources provided by the resource provider.

The update message indicates a change in an association between the resource and metadata, a schema, and/or a metadata-schema domain. The change can be a new association between the resource and metadata, the deletion of an association between the resource and metadata, and/or other change in an association between the resource and metadata. An association between the resource and metadata can be maintained by a MRN representing the metadata-schema domain of the schema to which the metadata conforms. The association can be stored in one or more records of a database or other data store.

According to one embodiment, the components illustrated in FIG. 7, including the domain manager component 702 can be adapted to operate in an execution environment 802 provided by a node, such as the RDN 504 or one of the RDNs 508, 510, 512 in the RD system 506. The domain manager component 702 can be a component of a resource directory (RD) service 804 operating in the execution environment 802. The domain manager component 702 can receive the update message from a MRN such as the MRN 526 as illustrated by the message 566. The message 566 can be a resource synchronization message described below for maintaining consistency between an RDN and an MRN. An update message can be received from a resource provider as result of change in a resource (e.g. a new resource, a deleted resource, and/or an otherwise changed resource) provided by a resource provider in a resource domain represented an RDN.

The update message can be received via the network 514 and a network subsystem 806. The RD service 804 can include a routing layer 808 configured to receive the update message. FIG. 5b illustrated RDNs 508, 510, 512 that can host the execution environment 802 and its components or a functionally analogous arrangement of components including a routing layer for receiving routing messages among the nodes of the RD system 506. The RD service 804 includes a domain switch component 810 configured to receive an update message and determine whether the resource is included in a resource domain represented by the RD service 804. When the resource is at least partially included in the resource domain of the RD service 804 the domain switch component 810 can be configured to provide the update message to the domain manager component 702.

When the resource is at least partially included in a resource domain not represented by the RD service 804 the domain switch component 810 can be configured to provide the update message to the routing layer 808 for routing the update message to another RDN in an RD system. The message is routed via network subsystem 806 to other resource directory services in other RDNs in the RD system 506.

Returning to FIG. 6, in block 604 a record is updated associating the resource and the metadata-schema domain. Accordingly, a system for providing access to metadata for an identified resource includes means for updating a record associating the resource and the metadata-schema domain. For example, as illustrated in FIG. 7, the resource association agent (RAA) component 704 is configured to update a record associating the resource and the metadata-schema domain.

The RAA component 704 updates association information in a record database 812. Note there can be more than one record in a metadata-schema domain and/or in a schema in a metadata-schema domain associated with a resource and a resource can have metadata that conforms to any number of schemas in one or more metadata-schema domains. As a result, the RAA component 704 may update a plurality of records. Each record includes at least one association between the resource and the metadata. An association identifies the resource and at least one metadata resource, schema defining valid metadata for the resource, metadata-schema domain including metadata for the resource, and/or an address of a metadata repository node that contains information for accessing metadata for the resource. Updating association information may include creating a new record associating the resource and the metadata-schema domain schema, deleting a record, and/or otherwise changing a record. Once a record has been updated or deleted, a metadata synchronization message can be sent to MRNs to maintain consistency between the data stored by the sending RDN and the MRN receiving the metadata synchronization message. Metadata synchronization messages are described further below including when a metadata synchronization message can be sent.

Returning to FIG. 6, in block 606 a metadata access request is received identifying the resource. Accordingly, a system for providing access to metadata for an identified resource includes means for receiving a metadata access request identifying the resource. For example, as illustrated in FIG. 7, a client message handler component 706 is configured to receive a metadata access request identifying the resource.

The client message handler component 706 in conjunction with domain manager component 702 can be configured to determine whether the resource is in the resource domain represented by the RDS 804. If the resource is not in the resource domain represented by the RDS 804, the metadata access request information is forwarded for routing by the routing layer 808 to an RDN that does represent the resource domain. For example, if the execution environment 802 is hosted by RDN 508 in the RD system 506 and the RDN 508 does not represent a resource domain that at least partially includes the resource, then the routing layer 808 of RDN 508 transmits the metadata access request or an equivalent message having the metadata access request information including an identification of the resource to one or more RDNs in RD system 506 and/or other RDNs in other RD systems for locating an accessor for metadata associated with the resource. The client message handler component 708 in the RDN 508 can receive a response message 560 to the routed request 558 from at least one RDN such as the RDN 510 that represents a metadata-schema domain including metadata for the resource. The response 560 includes an accessor or access information for generating an accessor for accessing the metadata. The accessor includes metadata associated with the resource and/or a locator for accessing the metadata such as a URL.

If the resource is in the resource domain represented by the RDS 804, the resource is identified by the RAA component 704 for example by performing a search in a record database 812. The RAA component 704 locates one or more records associating the resource with a metadata-schema domain represented by a MRN. Note that what is in the record can vary according to its preciseness. The record data received from the RAA 704 and/or from at least one other RDN is provided to the client message handler component 706 as illustrated in FIG. 7 and in FIG. 8.

Returning to FIG. 6, in block 608 a metadata access response is generated including an accessor based on the metadata-schema domain for accessing metadata, in the metadata-schema domain, for the resource. Accordingly, a system for providing access to metadata for an identified resource includes means for generating a metadata access response including an accessor based on the metadata-schema domain for accessing metadata, in the metadata-schema domain, for the resource. For example, as illustrated in FIG. 7, the client message handler component 706 is further configured to generate a metadata access response including an accessor based on the metadata-schema domain for accessing metadata, in the metadata-schema domain, for the resource.

Returning to FIG. 6, in block 610 the metadata access response is transmitted as a response to the metadata access request. Accordingly, a system for providing access to metadata for an identified resource includes means for transmitting the metadata access response as a response to the metadata access request. For example, as illustrated in FIG. 7, the client message handler component 706 is further configured to transmit the metadata access response as a response to the metadata access request.

The client message handler component 706 can transmit the metadata access response to the sender of the metadata access request. Additionally and/or alternatively, the metadata access response is transmitted to a recipient identified in the metadata access request.

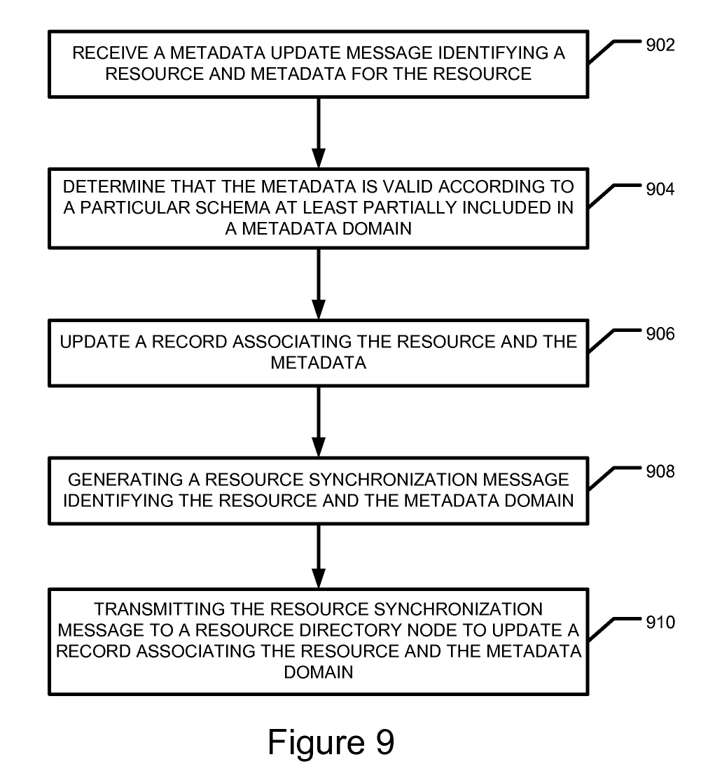

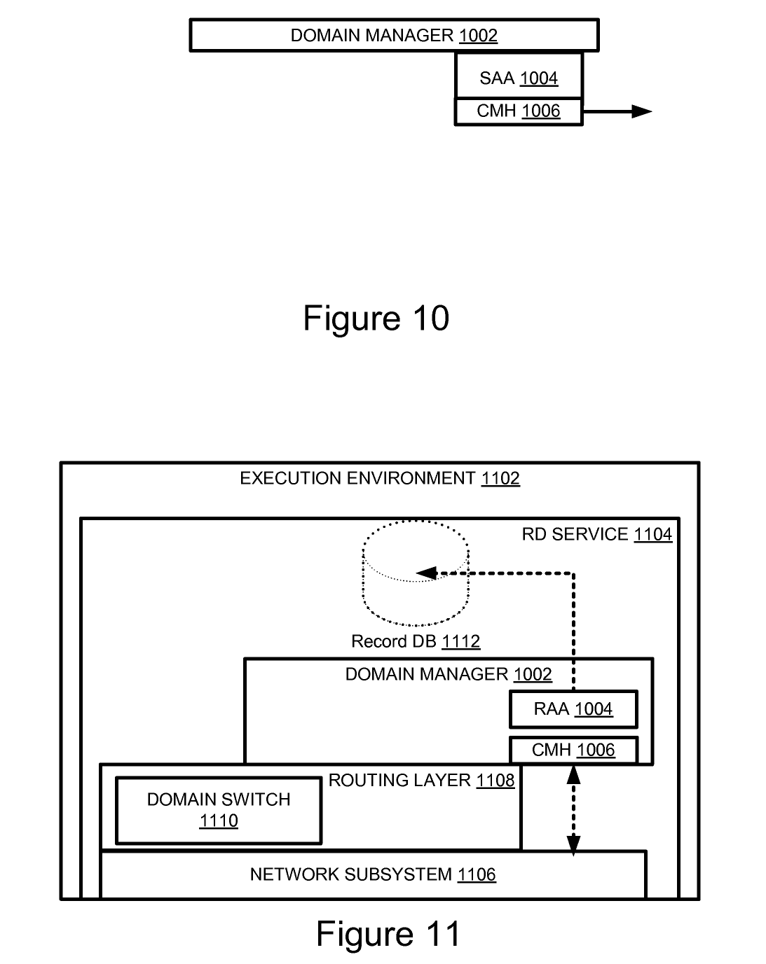

As previously indicated, the records in a RDN and a MRN should be synchronized with each other. FIG. 9 is a flow diagram illustrating a method for providing access to metadata for an identified resource according to an exemplary aspect of the subject matter described herein from the perspective of an MRN, such as MRN 526, first MRN 518, second MRN 520, and one or more other MRNs including an Nth MRN 522. The MRN 526 may represent a metadata-schema domain in a different domain name space represented by the MDRS 524 and its MRNs. FIG. 10 is a block diagram illustrating a system for providing access to metadata for an identified resource according to another exemplary aspect of the subject matter described herein. FIG. 11 is a block diagram illustrating an arrangement of components providing an execution environment configured for hosting the arrangement of components depicted in FIG. 10. The method in FIG. 9 can be carried out by, for example, some or all of the components illustrated in the exemplary arrangement in FIG. 10 operating in an a compatible execution environment, such as the environment provided by some or all of the components of the arrangement in FIG. 11. The arrangement of components in FIG. 11 may be implemented by some or all of the components of the hardware device 100 of FIG. 1.

With reference to FIG. 9, in block 902 a metadata update message is received identifying a resource and metadata for the resource. Accordingly, a system for providing access to metadata for an identified resource includes means for receiving a metadata update message identifying a resource and metadata for the resource. For example, as illustrated in FIG. 7, a domain manager component 1002 is configured to receive a metadata update message identifying a resource and metadata for the resource.

According to an exemplary embodiment, the metadata update message may be received over a network in a received message and/or from a local source. For example, the received metadata update message can be a response to a request, a notification associated with a subscription, and/or an unsolicited asynchronous message. The local source may be input received from a user. The update message indicates a change in an association between the resource and metadata. The change can be a new association between the resource and metadata, the deletion of an association between the resource and metadata, and/or other change in an association between the resource and metadata. The association can be stored in one or more records of a record database 1112 or other data store.

According to one embodiment, the components illustrated in FIG. 10, including the domain manager component 1002 can be adapted to operate in an execution environment 1102 provided by a node, such as the MRN 526 or one of the MRNs 518, 520, 522 in the MDRS 524. The domain manager component 1002 can be a component of a metadata repository (MR) service 1104 operating in the execution environment 1102. The domain manager component 1002 can receive the metadata update message from a RDN such as the RDN 504 as illustrated by the message 566. The message 566 can be a resource synchronization message described below for maintaining consistency between an RDN and an MRN. A metadata update message can be received from a resource provider as result of change in metadata associated with a resource (e.g. new metadata, deleted metadata, and/or an otherwise changed metadata) provided by a resource provider in a metadata-schema domain represented by a MRN.

The metadata update message can be received via the network 514 or via the RD system 506 or MDRS 524 and a network subsystem 1106. The MR service 1104 can include a routing layer 1108 configured to receive the metadata update message. FIG. 5b illustrated MRNs 518, 520, 522 that can host the execution environment 1102 and its components or a functionally analogous arrangement of components including a routing layer for receiving routing messages among the nodes of the MDRS 524. The MR service 1104 includes a domain switch 1110 configured to receive a metadata update message and determine whether the metadata is included in a metadata-schema domain represented by the MR service 1104. When the metadata is at least partially included in the metadata-schema domain of the MR service 1104 the domain switch component 1110 can be configured to provide the metadata update message to the domain manager component 1102.

When the metadata-schema associated with the metadata to be updated is at least partially included in a metadata-schema domain not represented by the MR service 1104 the domain switch 1110 can be configured to provide the metadata update message to the routing layer 1108 for routing the update message to another MRN in an MDRS. The message is routed via network subsystem 1106 to other metadata repository services in other MRNs in the MDRS 524.

Returning to FIG. 9, in block 904, a determination is made that the metadata is valid according to a particular schema at least partially included in a metadata-schema domain. Accordingly, a system for providing access to metadata for an identified resource includes means for determining that the metadata is valid according to a particular schema at least partially included in a metadata-schema domain. For example, as illustrated in FIG. 10, a resource association agent (RAA) component 1004 is configured to determine that the metadata is valid according to a particular schema at least partially included in a metadata-schema domain.

The RAA component 1004 compares the metadata to schemas stored in metadata record database 1112. If the metadata conforms to a schema, the determination is made that the metadata is valid according to a particular schema in the metadata-schema domain represented by the MR service 1104.

Returning to FIG. 9, in block 906, a record is updated associating the resource and the metadata. Accordingly, a system for providing access to metadata for an identified resource includes means for updating a record associating the resource and the metadata. For example, as illustrated in FIG. 10, the resource association agent (RAA) component 1004 is further configured to update a record associating the resource and the metadata.

The RAA component 1104 updates association information in a record database 1112. Note there can be more than one record in a metadata-schema domain and/or in a schema in a metadata-schema domain associated with a resource and a resource can have metadata that conforms to any number of schemas in one or more metadata-schema domains. As a result, the RAA component 1104 may update a plurality of records. Each record includes at least one association between the resource and the metadata. An association identifies the resource and at least one metadata resource, schema defining valid metadata for the resource, and/or metadata-schema domain including metadata for the resource. Updating association information may include creating a new record associating the resource and the metadata, deleting a record, and/or otherwise changing a record.

Returning to FIG. 9, in block 908, a resource synchronization message identifying the resource and the metadata-schema domain is generated. Accordingly, a system for providing access to metadata for an identified resource includes means for generating a resource synchronization message identifying the resource and the metadata-schema domain. For example, as illustrated in FIG. 10, a client message handler component 1006 is configured to generate a resource synchronization message identifying the resource and the metadata-schema domain.

Once a record has been updated or deleted, a resource synchronization message can be generated to maintain consistency between the data stored by the sending MRN and the RDN receiving the resource synchronization message.

Returning to FIG. 9, in block 910, the resource synchronization message is transmitted to a resource directory node to update a record associating the resource and the metadata-schema domain. Accordingly, a system for providing access to metadata for an identified resource includes means for transmitting the resource synchronization message to a resource directory node to update a record associating the resource and the metadata-schema domain. For example, as illustrated in FIG. 10, the client message handler component 1006 is further configured to transmit the resource synchronization message to a resource directory node to update a record associating the resource and the metadata-schema domain.

Once a resource synchronization message is generated, it can be sent to RDNs to maintain consistency between the data stored by the sending MRN and the RDN receiving the resource synchronization message. For example, a resource synchronization message illustrated as message 566 can be sent from MRN 526 to RDN 504.

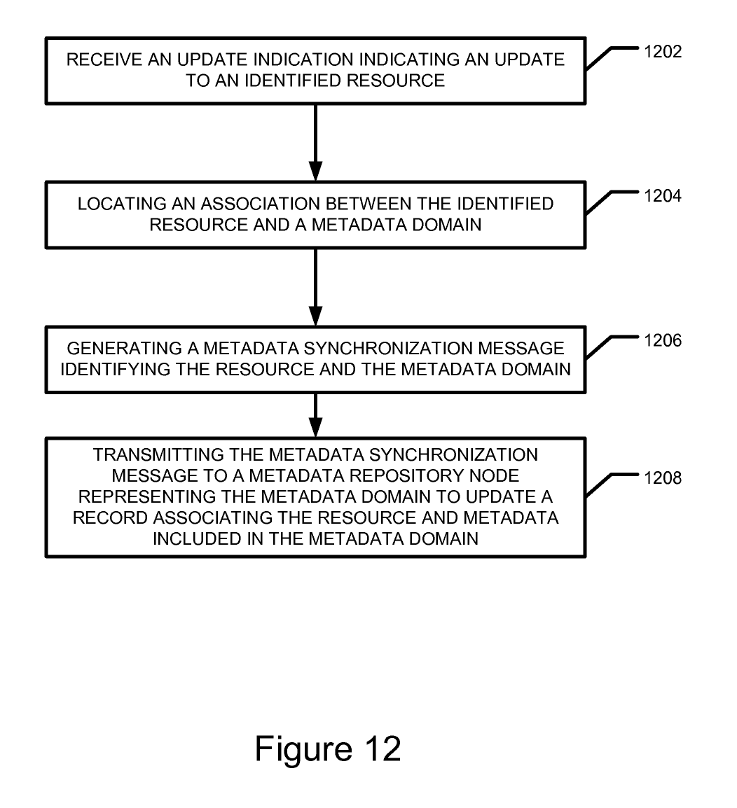

FIG. 12 is a flow diagram illustrating a method for providing access to metadata for an identified resource according to an exemplary aspect of the subject matter described herein from the perspective of a RDN. The method in FIG. 12 can be carried out by, for example, some or all of the components illustrated in the exemplary arrangement in FIG. 7 operating in an a compatible execution environment, such as the environment provided by some or all of the components of the arrangement in FIG. 8. The arrangement of components in FIG. 8 may be implemented by some or all of the components of the hardware device 100 of FIG. 1.

With reference to FIG. 12, in block 1202 an update indication is received indicating an update to an identified resource. Accordingly, a system for providing access to metadata for an identified resource includes means for receiving an update indication indicating an update to an identified resource. For example, as illustrated in FIG. 7, a domain manager component 702 is configured to receive an update indication indicating an update to an identified resource.

According to an exemplary embodiment, the update indication may be received over a network in a received message and/or from a local source. For example, the received update indication can be a response to a request, a notification associated with a subscription, and/or an unsolicited asynchronous message. The local source may be input received from a user.

The update indication can be received from a resource provider as result of change in a resource (e.g. a new resource, a deleted resource, and/or an otherwise changed resource) provided by a resource provider in a resource domain represented an RDN.

The update message can be received via the network 514 and a network subsystem 806. The RD service 804 can include a routing layer 808 configured to receive the update message. As previously indicated, FIG. 5b illustrates RDNs 508, 510, 512 that can host the execution environment 802 and its components or a functionally analogous arrangement of components including a routing layer for receiving routing messages among the nodes of the RD system 506. The RD service 804 includes a domain switch component 810 configured to receive an update indication and determine whether the resource is included in a resource domain represented by the RD service 804. When the resource is at least partially included in the resource domain of the RD service 804 the domain switch component 810 can be configured to provide the update indication to the RAA component 702.

With reference to FIG. 12, in block 1204 an association between the identified resource and a metadata-schema domain is located. Accordingly, a system for providing access to metadata for an identified resource includes means for locating an association between the identified resource and a metadata-schema domain. For example, as illustrated in FIG. 7, the RAA component 704 is configured to locate an association between the identified resource and a metadata-schema domain.

The RD service 804 includes a domain switch component 810 configured to receive an update indication and determine whether the resource is included in a resource domain represented by the RD service 804. When the resource is at least partially included in a resource domain not represented by the RD service 804 the domain switch 810 can be configured to provide the update indication to the routing layer 808 for routing the update message to another RDN in an RD system. The message is routed via network subsystem 806 to other resource directory services in other RDNs in the RD system 506. When the resource is at least partially included in the resource domain of the RD service 804 the domain switch component 810 can be configured to provide the update indication to the domain manager component 702. The domain manager component 702 provides the update indication to the RAA component 704.

The RAA component 704 locates the association between the identified resource and the metadata-schema domain in the record database 812. Note that there can be more than one association. As a result, the RAA component 704 may update a plurality of records that have an association between the identified resource and a metadata-schema domain.

With reference to FIG. 12, in block 1206 a metadata synchronization message is generated identifying the resource and the metadata-schema domain. Accordingly, a system for providing access to metadata for an identified resource includes means for generating a metadata synchronization message identifying the resource and the metadata-schema domain. For example, as illustrated in FIG. 7, a client message handler component 706 is configured to generate a metadata synchronization message identifying the resource and the metadata-schema domain.

Once a record has been updated or deleted, a metadata synchronization message can be generated to maintain consistency between the data stored by the sending RDN and an MRN receiving the metadata synchronization message.

With reference to FIG. 12, in block 1208 the metadata synchronization message is transmitted to a metadata repository node representing the metadata-schema domain to update a record associating the resource and metadata included in the metadata-schema domain. Accordingly, a system for providing access to metadata for an identified resource includes means for transmitting the metadata synchronization message to a metadata repository node representing the metadata-schema domain to update a record associating the resource and metadata included in the metadata-schema domain. For example, as illustrated in FIG. 7, a client message handler component 706 is further configured to transmit the metadata synchronization message to a metadata repository node representing the metadata-schema domain to update a record associating the resource and metadata included in the metadata-schema domain.

In an embodiment, each record has an address of a MRN that contains information for accessing metadata for the resource. The client message handler component 706 can transmit the metadata synchronization message to MRNs

The use of the terms “a” and “an” and “the” and similar referents in the context of describing the subject matter (particularly in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. Furthermore, the foregoing description is for the purpose of illustration only, and not for the purpose of limitation, as the scope of protection sought is defined by the claims as set forth hereinafter together with any equivalents thereof entitled to. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the invention as claimed.

Preferred embodiments are described herein, including the best mode known to the inventor for carrying out the claimed subject matter. Of course, variations of those preferred embodiments will become apparent to those of ordinary skill in the art upon reading the foregoing description. The inventor expects skilled artisans to employ such variations as appropriate, and the inventor intends for the claimed subject matter to be practiced otherwise than as specifically described herein. Accordingly, this claimed subject matter includes all modifications and equivalents of the subject matter recited in the claims appended hereto as permitted by applicable law. Moreover, any combination of the above-described elements in all possible variations thereof is encompassed unless otherwise indicated herein or otherwise clearly contradicted by context.

1. A method for providing access to metadata for an identified resource, the method comprising:
receiving resource information identifying a resource and identifying a resource domain of a resource provider of the resource;
generating a metadata access request identifying the resource and identifying the resource domain;
transmitting the metadata access request for routing based on the resource domain to a resource directory node representing the resource domain for accessing a record associating the resource with metadata for the resource, the metadata in a metadata-schema domain represented by a metadata repository node; and
receiving an accessor for accessing the metadata in response to the metadata access request,
wherein at least one of the preceding actions is performed on at least one electronic hardware component.

2. The method of claim 1 wherein the resource information identifies a resource uniform resource location (URL) identifying the resource and identifying the resource domain.

3. The method of claim 1 wherein the accessor includes a uniform resource identifier (URI) identifying a schema for validating the metadata.

4. The method of claim 1 further comprising including the accessor in a message transmitted for routing to the metadata repository node to access the record.

5. The method of claim 1 wherein the accessor includes the metadata.

6. The method of claim 1 wherein the metadata is associated with a schema for validating the metadata.

7. The method of claim 1 wherein the resource directory node hosts a resource directory configured to maintain the record associating the resource and the metadata.

8. The method of claim 7 wherein the resource directory node is a node in a plurality of nodes hosting resource directories in a resource directory system.

9. The method of claim 7 wherein transmitting the metadata access request comprises determining a network address of a node configured to route the metadata access request to the resource directory service based on the resource domain.

10. A method for providing access to metadata for an identified resource, the method comprising:
receiving by resource directory node an update message identifying a resource and identifying a metadata-schema domain;
updating a record associating the resource and the metadata-schema domain;
receiving a metadata access request identifying the resource;
generating a metadata access response including an accessor based on the metadata-schema domain for accessing the metadata, in the metadata-schema domain, for the resource identified by the metadata access request; and
transmitting the metadata access response as a response to the metadata access request,
wherein at least one of the preceding actions is performed on at least one electronic hardware component.

11. The method of claim 10 wherein generating the metadata access response includes
generating a metadata service request identifying the metadata-schema domain;
transmitting the metadata service request to a metadata repository node for locating a record associating the resource with metadata wherein the metadata is valid according to a schema included in the metadata-schema domain;
receiving a metadata service response including the access information based on the located record; and
generating the metadata access response including the accessor based on the access information.

12. The method of claim 10 wherein updating the record includes at least one of creating, deleting, and updating a record associating the resource and the metadata-schema domain.

13. The method of claim 10 wherein when the resource is determined not to be in a resource domain represented by a resource directory service hosted by the resource directory node, the method further comprises sending the metadata access request to another resource directory service to generate and transmit the metadata access response.

14. The method of claim 13 wherein the resource directory service and the other resource directory service are included in a same resource directory system.

15. The method of claim 10 wherein the update record identifies the resource and identifies at least one of a specific metadata record valid according to the schema, a schema at least partially included in the identified metadata-schema domain, a metadata-schema domain identifier, and an address of a metadata repository node.

16. The method of claim 10 further comprising routing a metadata synchronization message to a metadata repository node in correspondence with updating the record.

17. The method of claim 16 wherein the metadata synchronization message is routed based on an identifier of the metadata-schema domain.

18. The method of claim 10 wherein the accessor identifies at least one of a metadata-schema domain, a schema and a metadata resource.

19. A method for providing access to metadata for an identified resource, the method comprising:
receiving a metadata update message identifying a resource and metadata for the resource;
determining that the metadata is valid according to a particular schema at least partially included in a metadata-schema domain;
updating a record associating the resource and the metadata;
generating a resource synchronization message identifying the resource and the metadata-schema domain; and
transmitting the resource synchronization message to a resource directory node to update a record associating the resource and the metadata-schema domain,
wherein at least one of the preceding actions is performed on at least one electronic hardware component.

20. A method for providing access to metadata for an identified resource, the method comprising:
receiving an update indication indicating an update to an identified resource;
locating an association between the identified resource and a metadata-schema domain;
generating a metadata synchronization message identifying the resource and the metadata-schema domain; and
transmitting the metadata synchronization message to a metadata repository node representing the metadata-schema domain to update a record associating the resource and metadata included in the metadata-schema domain,
wherein at least one of the preceding actions is performed on at least one electronic hardware component.

21. A system for providing access to metadata for an identified resource, the system comprising:
means for receiving resource information identifying a resource and identifying a resource domain of a resource provider of the resource;
means for generating a metadata access request identifying the resource and identifies the resource domain;
means for transmitting the metadata access request for routing based on the resource domain to a resource directory node representing the resource domain for accessing a record associating the resource with metadata for the resource, the metadata in a metadata-schema domain represented by a metadata repository node; and
means for receiving an accessor for accessing the metadata in response to the metadata access request,
wherein at least one of the means includes at least one electronic hardware component.

22. A system for providing access to metadata for an identified resource, the system comprising system components including:
a resolver interface component configured to receive resource information identifying a resource and identifying a resource domain of a resource provider of the resource;
a messaging agent component configured to generate a metadata access request identifying the resource and identifying the resource domain; and
a resource directory service component configured to transmit the metadata access request for routing based on the resource domain to a resource directory node representing the resource domain for accessing a record associating the resource with metadata for the resource, the record in a metadata-schema domain represented by a metadata repository node, the
resource directory service component configured to receive an accessor for accessing the metadata in response to the metadata access request,
wherein at least one of the system components includes at least one electronic hardware component.

23. The system of claim 22 wherein the accessor includes a uniform resource identifier (URI) identifying a schema for validating the metadata.

24. The system of claim 22 wherein the resource directory service component is further configured to include the accessor in a message transmitted for routing to the metadata repository node to access the record.

25. The system of claim 22 wherein the accessor includes the metadata.

26. The system of claim 22 wherein the resource directory node hosts a resource directory configured to maintain the record associating the resource and the metadata.

27. The system of claim 26 wherein the resource directory node is a node in a plurality of nodes hosting resource directories in a resource directory system.

28. The system of claim 26 wherein the resource directory service component is further configured to determine a network address of a node configured to route the metadata access request to the resource directory service based on the resource domain.

29. A system for providing access to metadata for an identified resource, the system comprising:
means for receiving receiving by resource directory node an update message identifying a resource and identifying a metadata-schema domain;
means for updating a record associating the resource and the metadata-schema domain;
means for receiving a metadata access request identifying the resource;
means for generating a metadata access response including an accessor based on the metadata-schema domain for accessing the metadata, in the metadata-schema domain, for the resource identified by the metadata access request; and
means for transmitting the metadata access response as a response to the metadata access request,
wherein at least one of the means includes at least one electronic hardware component.

30. A system for providing access to metadata for an identified resource, the system comprising system components including:
a domain manager component configured to receive an update message identifying a resource and a metadata-schema domain;
a resource association agent component configured to update a record associating the resource and the metadata-schema domain; and
a client message handler component configured to receive a metadata access request identifying the resource,
the client message handler component further configured to generate a metadata access response including an accessor based on the metadata-schema domain for accessing the metadata, in the metadata-schema domain, for the resource identified by the metadata access request, and
the client message handler component further configured to transmit the metadata access response as a response to the metadata access request,
wherein at least one of the system components includes at least one electronic hardware component.

31. The system of claim 30 wherein the client message handler generates metadata access response by:
generating a metadata service request identifying the metadata-schema domain;
transmitting the metadata service request to a metadata repository node for locating a record associating the resource with metadata wherein the metadata is valid according to a schema included in the metadata-schema domain;
receiving a metadata service response including the access information based on the located record; and
generating the metadata access response including the accessor based on the access information.

32. The system of claim 30 wherein the resource association agent component is configured to update the record by at least one of creating, deleting, and updating a record associating the resource and the metadata-schema domain.

33. The system of claim 30 wherein when the resource is determined not to be in a resource domain represented by a resource directory hosted by the resource directory node, the client message handler component is further configured to send the metadata access request to another resource directory service to generate and transmit the metadata access response.

34. The system of claim 33 wherein the resource directory service and the other resource directory are included in a same resource directory system.

35. The system of claim 30 wherein the updated record identifies the resource and identifies at least one of a specific metadata record valid according to the schema, a schema at least partially included in the identified metadata-schema domain, a metadata-schema domain identifier, and an address of a metadata repository node.

36. The system of claim 30 wherein the client message handler component is further configured to route a metadata synchronization message to a metadata repository node in correspondence with updating the record.

37. The system of claim 36 wherein the client message handler component is further configured to route the metadata synchronization message based on an identifier of the metadata-schema domain.

38. The system of claim 30 wherein the accessor identifies at least one of a metadata-schema domain, a schema, and a metadata resource.

39. A system for providing access to metadata for an identified resource, the system comprising:
means for receiving a metadata update message identifying a resource and metadata for the resource;
means for determining that the metadata is valid according to a particular schema at least partially included in a metadata-schema domain;
means for updating a record associating the resource and the metadata;
means for generating a resource synchronization message identifying the resource and the metadata-schema domain; and
means for transmitting the resource synchronization message to a resource directory node to update a record associating the resource and the metadata-schema domain,
wherein at least one of the means includes at least one electronic hardware component.

40. A system for providing access to metadata for an identified resource, the system comprising:
means for receiving an update indication indicating an update to an identified resource;
means for locating an association between the identified resource and a metadata-schema domain;
means for generating a metadata synchronization message identifying the resource and the metadata-schema domain; and
means for transmitting the metadata synchronization message to a metadata repository node representing the metadata-schema domain to update a record associating the resource and metadata included in the metadata-schema domain,
wherein at least one of the means includes at least one electronic hardware component.

41. A computer readable medium storing a computer program, executable by a machine, for providing access to metadata for an identified resource, the computer program comprising executable instructions for:
receiving resource information identifying a resource and identifying a resource domain of a resource provider of the resource;
generating a metadata access request identifying the resource and identifying the resource domain;
transmitting the metadata access request for routing based on the resource domain to a resource directory node representing the resource domain for accessing a record associating the resource with metadata for the resource, the metadata in a metadata-schema domain represented by a metadata repository node; and
receiving an accessor for accessing the metadata in response to the metadata access request.

42. A computer readable medium storing a computer program, executable by a machine, for providing access to metadata for an identified resource, the computer program comprising executable instructions for:
receiving an update message identifying a resource and identifying a metadata-schema domain;
updating a record associating the resource and the metadata-schema domain;
receiving a metadata access request identifying the resource;
generating a metadata access response including an accessor based on the metadata-schema domain for accessing the metadata, in the metadata-schema domain, for the resource identified by the metadata access request; and
transmitting the metadata access response as a response to the metadata access request.
